(19) United States
(12) Patent Application Publication
(10) Pub. No.: US 2024/0123424 A1
(43) Pub. Date: Apr. 18, 2024

(54) WATER PURIFICATION BY IP6-CITRATE

(71) Applicant: AbulKalam Mohammed Shamsuddin, Lutherville, MD (US)

(72) Inventor: AbulKalam Mohammed Shamsuddin, Lutherville, MD (US)

(21) Appl. No.: 18/278,332

(22) PCT Filed: Feb. 23, 2022
(86) PCT No.: PCT/US2022/017514

§ 371 Date: Aug. 22, 2023

Related U.S. Application Data
(60) Provisional application No. 63/153,142, filed on Feb. 24, 2021.

(51) Int. Cl. B01J 20/24; B01J 20/28; B01J 20/30; C02F 1/28; C08B 15/05

(52) U.S. Cl. CPC B01J 20/24; B01J 20/28016; B01J 20/3085; C02F 1/286; C08B 15/05; C02F 2101/22

(57) ABSTRACT

This invention provides for removal of toxic heavy metal contamination from water using inositol hexakisphosphate. Inositol hexakisphosphate (InsP₆ or IP₆ aka phytic acid) is a ubiquitous polyphosphorylated carbohydrate with numerous biological and industrial functions including chelation of cations. IP₆ hexa-citrate (IP₆-citrate) was synthesized and characterized for use as metal chelator in the purification of water. The synthesized IP₆-citrate was used to modify the surface of cellulose and the IP₆-citrate-modified cellulose subsequently used to remove Pb, Cr and Cd from aqueous solutions. Atomic Absorption Spectrometry and differential pulse anodic stripping Voltammetry were used to test the levels of the heavy metals in water samples before and after the application of IP₆-citrate-modified cellulose. The use of IP₆-citrate modified cellulose decreased the amount of Cd, Cr and Pb in the water samples by 95-99%. IP₆-citrate modified cellulose was superior to IP₆-cellulose alone.

### CROSS REFERENCE TO RELATED APPLICATION

This application claims priority to U.S. Provisional Patent Application Ser. No. 63/153,142 filed Feb. 24, 2021, the disclosure of which is herein incorporated by reference in its entirety.

### FIELD

The current invention relates of improved synthesis of IP₆ Citrate and attaching it to cellulose for removal of toxic heavy metal contaminants from our water supply.

The invention provides important benefits from a public health point of view in removing contaminating toxic metals such as antimony, arsenic, cadmium, cerium, chromium, copper, europium, nickel, lead, mercury, molybdenum, zinc; and other cations from our water supply especially drinking water. The technology can be used either at home or in collective water supply for a community however small or large that may be.

### BACKGROUND

Elements having atomic weights between 63.5 and 200.6 with specific gravity greater than 5 are considered heavy metals. They are naturally present in our environment and are toxic even at low concentrations. These—antimony, arsenic (both the trivalent and pentavalent forms), cadmium, cerium, chromium, copper, europium, nickel, lead, mercury, molybdenum, zinc; are nonbiodegradable and may remain as chemical form or as mixed form. Ionic forms of these e.g., Pb²⁺, As³⁺, Hg², Cd²⁺, etc. react with biomolecules in the body resulting in toxicity; thus, posing great challenge for their removal. Heavy metals may be converted to hydrated ions which are more toxic than the metal atoms when discharged in the river. In open water bodies such as ponds, rivers, lakes, etc., heavy metals cause decreased oxygen concentration resulting in algal bloom and death of aquatic life.

Aside from natural sources, heavy metal contamination from wastewater from rapid urbanization, industrialization, mining etc., greatly affects our environment. The release of untreated wastewater from the industries is the major source of the water pollution. The effluent originating from the industries containing pollutants is discharged into the rivers or other water resources.

Thus, the presence of heavy metals in the environment, particularly in the water we drink, poses a serious challenge to the health and wellbeing of mankind, besides other life forms even at very low concentrations. Heavy metals are found naturally in earth; lead (Pb) has been the most prevalent contaminant of them all. It has been implicated in several disorders such as kidney failure and acute encephalopathy. Cancer is one of the long-term effects of arsenic, chromium (hexavalent Cr or Chromium VI) and cadmium poisoning, besides other health problems.

The various techniques for removal of heavy metals from water include adsorption, chemical precipitation, coagulation/flocculation, electrochemical treatment, electrodialysis, flotation, ion exchange, membrane filtration, oxidation and photocatalysis. While each of these remove the heavy metals with variable efficiency, they suffer from various disadvantages viz. high cost, generation of sludge, need for electricity, long reaction time, etc. Thus, better technologies, especially ecofriendly, are needed to provide humanity with affordable, cost-effective, easy to use and efficient filtration system for their drinking water—a fundamental human right. A combination of two natural and safe components IP6 and citric acid: IP6-citrate in the instant invention had been demonstrated to be the most efficient of all the chelators tested (U.S. Pat. No. 7,517,868).

Insofar as human health is concerned, it is of paramount importance that these toxic heavy metals be removed from the environment which is done by chelating agents—compounds that react with heavy metals rendering them inert so that they can be excreted from the body without causing much harm; ethylenediaminetetraacetate (EDTA) is one such agent. But we need to remove them from the drinking water; trying to remove them from the body is too late—damage is already done to the body.

Inositol hexakisphosphate (InsP₆ or IP₆ aka phytic acid) is a ubiquitous polyphosphorylated carbohydrate with numerous biological and industrial functions including chelation of cations. IP₆ hexa-citrate is a good candidate for use as an effective metal chelator owing to the fact that its constituent components of IP₆ and citric acid have been successfully used in metal chelation in the past.¹¹⁻¹³ IP₆ is a naturally occurring compound that has been exploited for the removal or chelation of unwanted metals.¹⁴⁻²² Aside from metals, IP₆ has also been used for the removal of both neutral indole and basic quinoline from model liquid fuel.²³ In some instances, IP₆ has been used in cation resin exchange for the removal of heavy metals.²⁴

IP₆ [1,2,3,4,5,6-hexakis(dihydrogen phosphate)myo-inositol] in general, consist of an inositol ring and at least one phosphate group. IP₆ is known to have a high affinity for many divalent mineral elements. This chelating effect of the phosphate groups endow IP₆ with the ability to bind readily to cations such as antimony, arsenic, cadmium, cerium, chromium, copper, europium, iron, nickel, lead, lithium, magnesium, mercury, molybdenum, potassium, sodium, zinc, etc.

Citric acid with three carboxylic acid groups has been used as chelating agent in several studies¹². Citric acid is widely used in chelating metals several heavy metals.^{12,30} Citric acid as a chelating agent improves performance of a heavy oil Hydrotreatment Catalyst²²

One of the effective techniques for the removal of heavy metals from the environment is the combined application of two chelating agents.²³⁻²⁵ In this study, two chelating agents are combined in one compound for the removal of Cd, Cr and Pb from aqueous solutions. The new chemical compound, hexa-citrated IP₆ was synthesized from IP₆ and citric acid.

### OBJECTS OF THE INVENTION

It is a general object of the disclosure to provide a method of preparation of IP₆-hexacitrate and the use of IP₆-hexacitrate in the filtration and purification of water.

One object of the disclosure provides a method of preparation of IP₆-hexacitrate-modified cellulose or other fibers to immobilize IP₆-hexacitrate.

Another object of the disclosure provides for a method of removal of toxic metals by IP6-citrate modified cellulose. Such toxic metals include, but are not limited to antimony, arsenic, cadmium, cerium, chromium, copper, europium, iron, nickel, lead, lithium, magnesium, mercury, molybdenum, potassium, sodium, and zinc.

Another object of the disclosure provides for the removal of toxic heavy metals from a personal water supply, a community water supply, or from wastewater. In certain aspects, the disclosure provides for the removal of toxic heavy metals from domestic wastewater; mining wastewater; and/or wastewater generated from industries but not restricted to the fabrication process, process dealing with paper and pulp, textile, chemicals and from different streams like cooling tower, boiler, and production line, etc.

Another object of the disclosure provides for a personal potable water purifier using IP₆-hexacitrate and/or IP₆-citrate modified cellulose.

In one aspect, the invention provides for a method for the removal of heavy metal contamination from water comprising contacting contaminated water with inositol hexakisphosphate-hexacitrate (IP₆-citrate) to produce purified water.

In certain embodiments, the IP₆-citrate is provided as a IP₆-citrate-modified cellulose material. In still other embodiments, the IP₆-citrate-modified cellulose is in the form of particles.

In certain embodiments, the IP₆-citrate-modified cellulose particles are mixed with contaminated water followed by filtration to remove the IP₆-citrate-modified cellulose particles. In some such embodiments, the IP₆-citrate-modified cellulose particles are mixed with contaminated water in an amount of about 0.25-2.5 g/kg contaminated water. In some such embodiments, the IP₆-citrate-modified cellulose particles are mixed with contaminated water for about 1-30 minutes.

In certain embodiments, the IP₆-citrate-modified cellulose particles are used to prepare a packed bed of IP₆-citrate-modified cellulose particles. In such embodiments, contaminated water is passed over the packed bed of IP₆-citrate-modified cellulose particles to produce the purified water.

In certain embodiments, the heavy metal contaminated water is contaminated with antimony, arsenic, cadmium, cerium, chromium, copper, europium, iron, nickel, lead, lithium, magnesium, mercury, molybdenum, potassium, sodium, zinc, or mixtures thereof.

In particular embodiments, the purified water contains 5% or less of the heavy metals contained in the heavy metal contaminated water; 2% or less of the heavy metals contained in the heavy metal contaminated water; or 1% or less of the heavy metals contained in the heavy metal contaminated water.

In another aspect, the invention provides a filtration device comprising IP₆-citrate. In some embodiments of the filtration device, the IP₆-citrate is an IP₆-citrate-modified cellulose.

In still another aspect, the invention provides a kit for purifying heavy metal contaminated water comprising IP₆-citrate and instructions for removing heavy metals from the heavy metal contaminated water using the IP₆-citrate. In some embodiments of the kit, the IP₆-citrate is provided as an IP₆-citrate-modified cellulose.

In yet another aspect, the invention provides a method for preparing IP₆-citrate-modified cellulose comprising reacting inositol hexakisphosphate with citric acid to form inositol hexakisphosphate-hexacitrate (IP₆-citrate); and reacting the IP₆-citrate with a cellulose containing material in a solvent to produce the IP6 citrate-modified cellulose.

Upon further study of the specification and appended claims, further objects and advantages of this invention will become apparent to those skilled in the art.

### BRIEF DESCRIPTION OF THE DRAWINGS

FIG. 1 is the synthetic scheme of the reaction of Na-IP₆ and citric acid to yield IP₆hexa-citrate.

FIG. 2 is a calibration curve and measurements for atomic absorption spectrometry and differential pulse anodic stripping voltammetry (METROHM 797 VA computrace) analyses of Cd²⁺ in IP₆-Cellulose and IP₆-Citrate-Cellulose.

FIG. 3 is a calibration curve and measurements for atomic absorption spectrometry and differential pulse anodic stripping voltammetry (METROHM 797 VA computrace) analyses of chromium Cr⁶⁺ IP₆ Citrate-Cellulose.

FIG. 4 shows the adsorption of IP₆-Ct-Cell using several additions of 20 mL 20 ppm Pb²⁺ added sequentially to IP₆-Ct-Cell; inset: corresponding bar chart (a); and Regeneration with HCl (b).

### DETAILED DESCRIPTION

The following is a detailed description provided to aid those skilled in the art in practicing the present disclosure. Those of ordinary skill in the art may make modifications and variations in the embodiments described herein without departing from the spirit or scope of the present disclosure. All publications, patent applications, patents, figures, and other references mentioned herein are expressly incorporated by reference in their entirety.

Unless otherwise defined, all technical and scientific terms used herein have the same meaning as commonly understood by one of ordinary skill in the art to which this disclosure belongs. The terminology used in the description is for describing particular embodiments only and is not intended to be limiting of the disclosure.

Where a range of values is provided, it is understood that each intervening value, to the tenth of the unit of the lower limit unless the context clearly dictates otherwise (such as in the case of a group containing a number of carbon atoms in which case each carbon atom number falling within the range is provided), between the upper and lower limit of that range and any other stated or intervening value in that stated range is encompassed within the disclosure. The upper and lower limits of these smaller ranges may independently be included in the smaller ranges is also encompassed within the disclosure, subject to any specifically excluded limit in the stated range. Where the stated range includes one or both of the limits, ranges excluding either both of those included limits are also included in the disclosure.

All numerical values within the detailed description and the claims herein are modified by “about” or “approximately” the indicated value, and take into account experimental error and variations that would be expected by a person having ordinary skill in the art.

The following terms are used to describe the present disclosure. Unless otherwise defined, all technical and scientific terms used herein have the same meaning as commonly understood by one of ordinary skill in the art to which this disclosure belongs. The terminology used in the description is for describing particular embodiments only and is not intended to be limiting of the disclosure.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, in certain methods described herein that include more than one step or act, the order of the steps or acts of the method is not necessarily limited to the order in which the steps or acts of the method are recited unless the context indicates otherwise.

IP6-Citrate and Cellulose Modification

In one aspect, the invention provides for IP₆-citrate and modified cellulose materials. Inositol hexakisphosphate is reacted with citric acid to form inositol hexakisphosphate-hexacitrate, also referred to as IP₆-hexa-citrate and IP₆ citrate. The reaction conditions are described herein but may also be produced by modifying the procedures outlined in U.S. Pat. Nos. 7,989,435 7,517,868 and 7,009,067 (incorporated herein by reference). In general, the reaction conditions, including reaction time, solvents, starting materials, amounts of starting materials used and recovery methods are not particularly limited.

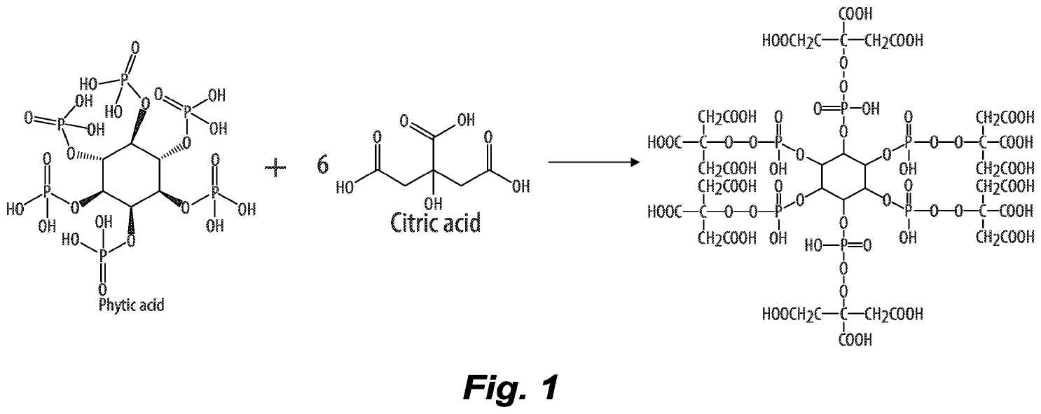

In another aspect, the invention provides for IP₆ citrate-modified materials, including, but not limited to IP₆ citrate-modified cellulose. In some embodiments, the cellulose is provided in crystalline form. In other embodiments, the cellulose is provided as fibers. In still other embodiments, the cellulose is provided as a non-woven fabric. The modification of the cellulose, regardless of form, can be achieved by mixing the IP₆ citrate with the cellulose material in a solvent. In particular embodiments, the modification of the cellulose can be achieved by mixing the IP₆ citrate with the cellulose material in water for a sufficient time to produce the IP₆ citrate-modified cellulose. The general reaction scheme is shown in FIG. 1. In general, the reaction conditions, including reaction time, solvents, starting materials, amounts of starting materials used and recovery methods are not particularly limited.

Methods of Removing Heavy Metals from Contaminated Water

In one aspect, the invention provides a method for the removal of heavy metal contamination from water comprising contacting contaminated water with inositol hexakisphosphate-hexacitrate (IP₆-citrate) to produce purified water.

In certain embodiments, the IP₆-citrate used in the methods of the invention is provided as a IP₆-citrate-modified cellulose material. In particular embodiments, the IP₆-citrate-modified cellulose is provided in the form of particles.

In some embodiments, the IP₆-citrate-modified cellulose particles are mixed with contaminated water followed by filtration to remove the IP₆-citrate-modified cellulose particles.

In some embodiments, the IP₆-citrate-modified cellulose material are mixed with contaminated water in an amount of about 0.1-5 g; about 0.25-2.5 g; or about 0.5-1.0 g. In certain embodiments, the IP₆-citrate-modified cellulose material are mixed with contaminated water in an amount of about 0.1-5 g/kg contaminated water; about 0.25-2.5 g/kg contaminated water; or about 0.5-1.0 g/kg contaminated water. In specific embodiments, the IP₆-citrate-modified cellulose material are mixed with contaminated water in an amount of about 0.1 g, about 0.25 g, about 0.5 g, about 0.75 g or about 1.0 g.

In some embodiments, the IP₆-citrate-modified cellulose material are mixed with contaminated water for a period of time sufficient to purify or otherwise remove contaminants from the contaminated water. In certain embodiments, the IP₆-citrate-modified cellulose material are mixed with contaminated water for about 1-30 minutes, about 5-20 minutes, or about 10-15 minutes. In specific embodiments, the IP₆-citrate-modified cellulose material are mixed with contaminated water for about 5 minutes, about 10 minutes, about 15 minutes, or about 20 minutes.

In still other embodiments, the IP₆-citrate-modified cellulose particles are used to prepare a packed bed of IP₆-citrate-modified cellulose particles. In such embodiments, contaminated water is passed over the packed bed of IP₆-citrate-modified cellulose particles to produce the purified water.

In particular embodiments, the heavy metal contaminated water is contaminated with antimony, arsenic, cadmium, cerium, chromium, copper, europium, iron, nickel, lead, lithium, magnesium, mercury, molybdenum, potassium, sodium, zinc, or mixtures thereof.

In some embodiments, the purified water contains 5% or less of the heavy metals contained in the heavy metal contaminated water. In particular embodiments, the purified water contains 4% or less of the heavy metals contained in the heavy metal contaminated water. In other particular embodiments, the purified water contains 3% or less of the heavy metals contained in the heavy metal contaminated water. In still other embodiments, the purified water contains 2% or less of the heavy metals contained in the heavy metal contaminated water. In other embodiments, the purified water contains 1% or less of the heavy metals contained in the heavy metal contaminated water. In particular embodiments, the purified water contains 0.75% or less, 0.50% or less, 0.25% or less, 0.10% or less, 0.05% or less, or 0.01% or less of the heavy metals contained in the heavy metal contaminated water.

Devices and Kits

The invention also provides for a filtration device comprising IP₆ hexa-citrate as the active material. In certain embodiments, the filtration device comprises IP₆ hexa-citrate-modified cellulose.

In some embodiments, the filtration device is provided as a filtration unit comprising the active material of the invention. In other embodiments, the filtration device may be configured to attach to a water pipe or a faucet.

In certain embodiments, the filtration unit may be a gravity percolation filtration unit which may be incorporated into a personal filtering water bottle. In such embodiments, the filtering water bottle is configured to filter water as it is added to the bottle. In one embodiment, the filtering water bottle includes the 1) gravity percolation filtration unit and a 2) reusable bottle with an open top end having a means of securing said filter wherein the bottle is configured to filter water on its way into the bottle via gravity. In one embodiment, the filter is bi-directional to allow filtering in and out of the bottle. The filter assembly may be a cylindrical housing comprising the IP₆ hexa-citrate and optionally one or more additional filtration elements, including, but not limited to, coarse media, such as activated carbon, and antimicrobial pellets designed to increase flow rate of liquid through the cylindrical housing while also helping to prevent bacterial growth in the filter. In a preferred non-limiting embodiment, the filtration media may be contained in the filter assembly itself. In another preferred non-limiting embodiment, the filtration media may be contained in a replaceable cartridge that fits into the filter assembly.

In certain embodiments, water enters the filter assembly through the entrance at the top, enters an overflow reservoir, passes into a cylindrical unit housing filter media, and exits through said cylindrical unit through the open end of the filter housing into the body of the bottle. The entrance of the filter assembly may contain features to accommodate a cap, by screw threads or interference fit. The entrance of the cylindrical unit may be positioned below a reservoir designed to catch excess outflow from the source. The entrance of the cylindrical filter may be covered with a porous material with pores greater than or equal to 400 microns to permit the expulsion of air from within the filter assembly. The exit of the filter may be covered with another porous material for containment of the coarse filter media. Preferred porous materials may have high wettability for reduced surface tension and higher filtration and flow rates. The filter encasing may have one or more ventilation hole(s) positioned and configured to vent air from inside the bottle chamber to outside the filter assembly as water displaces air inside the bottle during bottle filling. The filter assembly may be attached to the bottle at the open end by screw threads or interference fit. In one embodiment, the user removes the filter and drinks from the bottle. In one embodiment, the user drinks the water coming back through the filter.

In certain embodiments, where the filtration device is configured to attach to a water pipe, the filtration device is placed downstream from the source of the water (for example, from a water meter). The water flows through the filtration device to purify the water before being used by the user. In other embodiments, where the filtration device is configured to attach to a faucet, the filtration device is configured to accept water from the faucet for filtration and to expel the purified water for use by the user.

The invention also provides for a kit comprising the IP₆ hexa-citrate materials as described herein and instructions for use. In one embodiment, the instructions are for use with a personal filtration device, such as a filtering water bottle. In another embodiment, the instructions for use are for adding the IP₆ hexa-citrate materials to contaminated water.

### EXAMPLES

IP₆ Hexa-Citrate and Use for Purification of Water

IP₆, citrate acid, 0.22 μm filter, and Sodium IP₆ were purchased from Fisher Scientific Company LLC, 4500 Turnberry Drive, Hanover Park Il 60133. Cellulose microcrystalline was purchased from Acros organics, Morris Plains, New Jersey, USA. Absorption spectroscopy was carried out with UV-3600 Plus from Shimadzu, MD, USA. FTIR spectra were obtained with a Thermo Nicolet iS50 FTIR. METROHM 797 VA computrace was used for the differential pulse anodic stripping Voltammetry at a Hanging mercury dropping electrode.

Synthesis of the IP₆ Hexa-Citrate

The procedures outlined in U.S. Pat. Nos. 7,989,435 7,517,868 and 7,009,067 (incorporated herein by reference) were modified to prepare IP₆ hexa-citrate. To synthesize IP₆ hexa-citrate, 28.30 g (30 mmol) of Sodium salt of IP₆ was dissolved in 30 mL of deionized water in a 500 mL Erlenmeyer flask equipped with a magnetic stirring bar and heated on a hotplate to a temperature of 50° C. To this solution, 34.60 g (180 mmol) of citric acid was added and the solution stirred at 90° C. for additional 30 min. The heat source was subsequently removed, and the solution refrigerated for about 8 hours until crystallization had ceased. The product was further dried to obtain crystals of hexa-citrated IP₆.

IP₆ Hexa-Citrate Modification of Cellulose

To produce IP₆-citrate modified cellulose, 20 g of Cellulose microcrystalline was combined in a beaker with 30 g of IP₆ hexa-citrate dissolved in 200 mL of deionized water and stirred for 2 h. The mixture was filtered, and the residue was dried in an oven at 50° C. for 24 h. Finally, the obtained particles were heated at 150° C. for 180 min. The IP₆-citrate modified cellulose thus formed was used in subsequent adsorption experiments.

Metal Ions Absorption Studies

The absorption measurements were carried out in 250 mL glass bottle. A specified amount of the IP₆-citrate modified cellulose was added to a specified volume of known concentration of Cd, Cr or Pb solution and stirred continuously at given time periods. Different concentrations of the IP₆-citrate modified cellulose and different period of incubations were explored to study the effect of concentration and time on the absorption. The particles were separated by filtering through a 0.22 μm filter. The concentrations of Cd, Cr and Pb before and after adsorption were measured using an atomic absorption spectrophotometer and METROHM 797 VA computrace. All adsorption experiments were conducted in triplicate.

Synthesis of IP₆ Hexa-Citrate (IP₆-CA) and Cellulose-IP₆-CA

The synthesized IP₆-citrate was used to modify the surface of cellulose to create IP₆-citrate-modified cellulose which served as chelating agent for the capture of the cadmium, chromium and lead.

The synthetic scheme is shown in FIG. 1.

Fourier Transform Infrared Studies

The surface of the IP₆-citrate modified cellulose was characterized using Fourier Transform Infrared (FTIR) studies. FTIR measurement was carried out on IP₆-citrate, cellulose, and IP₆-citrate modified cellulose. The spectra were recorded in the range 600-4000 cm⁻¹. The original cellulose and the IP₆-citrate modified cellulose had similar spectrum and yielded peaks at 1510 cm⁻¹, 1707 cm⁻¹, 1721 cm⁻¹, and 2890 cm⁻¹. The peak at 3600 cm⁻¹ represents hydroxyl, phenol, and acids.

Analysis of Cadmium, Chromium, and Lead in Water Before and After IP₆-Citrate Modified Cellulose Treatment:

Atomic Absorption Spectroscopy measurements were carried out to determine the amount of Pb²⁺, Cr⁶⁺, and Cd²⁺ in their respective sample before and after their interaction with the IP₆-citrate modified cellulose. To carry out these measurements, standards solutions were prepared for the calibration prior to the testing of the various sample solutions. The calibration was done with standard solutions of concentration between 0.625 ppm and 20 ppm. The correlation coefficient of the graph for each of the element was more 0.996. Experiments were first performed to obtain optimal conditions and parameters for all the analysis. To determine the optimum amount of IP₆-Ct-cell needed for the optimum removal of metal ions from solution, different concentrations of Pb²⁺ (5 ppm, 10 ppm, and 20 ppm) were added to two different masses of IP₆-citrate-cellulose (0.5 g, and 1.5 g) in Mason jars equipped with magnetic stirring bars and stirred for 10 minutes. Afterward, the mixture was filtered, and the filtrate was used in the analysis. The results showed that a small quantity of the IP₆-citrate modified cellulose has the capacity to remove a large amount of the Pb²⁺ from the solution. Consequently 0.5 g of the IP₆ compound was used for subsequent analysis. Furthermore, to monitor Pb levels in samples after the adsorption incubation with IP₆-Ct-Cell over different time periods, 1.0 grams of IP₆-citrate modified cellulose was measured and transferred into a 100 mL Mason jar. This was repeated for two other Mason jars. 20 mL of 20 ppm Pb²⁺ solution was added, and the entire mixture stirred at room temperature for 1 min, 5 min, and 20 min and afterward the mixture was filtered, and the filtrate was used in the analysis of Pb²⁺. More than 90% of Pb²⁺ was removed IP₆-citrate modified cellulose consistently for all of the three samples; the optimum removal took place after 5 min of stirring.

To test the concentration of Pb²⁺, Cr⁶⁺, and Cd²⁺ after their interaction with IP₆-Ct-Cell, 0.5 g of the IP₆-Ct-Cell was weighed into a Mason jar equipped with a magnetic stirring bar and 20 mL of the respective metal ion solution was added to it. After the stirring of 0.5 g of IP₆-Ct-Cell with the solution of the heavy metal for 15 minutes, the supernatant solution was filtered, and the heavy metal content determined by atomic absorption spectrometry (AAS). The amount detected after filtering the supernatant was 0.30 ppm, 0.33 ppm and 0.93 ppm, for Pb²⁺, Cr⁶⁺, and Cd²⁺, respectively. Thus, the use of IP₆-Ct-Cell resulted in 98.53%, 98.36%, and 95.36% removal of Pb²⁺, Cr⁶⁺, and Cd²⁺ respectively (Table 1).

TABLE 1
IP₆-Ct-Cell with different concentrations
of lead, cadmium, and chromium.

| | Amount | Amount | Percent | |
|---|---|---|---|---|
| With | Added | Detected | removed | Std |
| IP₆-Ct-Cell | (ppm) | (ppm) | (%) | Deviation |
| Lead | 20 | 0.41 | | |
| Lead | 20 | 0.26 | | |
| Lead | 20 | 0.22 | | |
| Lead average | 20 | 0.30 | 98.53 | ±0.013 |
| Cadmium | 20 | 0.94 | | |
| Cadmium | 20 | 0.98 | | |
| Cadmium | 20 | 0.87 | | |
| Cadmium Avg | 20 | 0.93 | 95.36 | ±0.030 |
| Chromium | 20 | 0.32 | | |
| Chromium | 20 | 0.31 | | |
| Chromium | 20 | 0.36 | | |
| Chromium Avg | 20 | 0.33 | 98.36 | ±0.056 |

Comparing the Effectiveness of IP₆-Ct-Cell Over IP₆-Cell

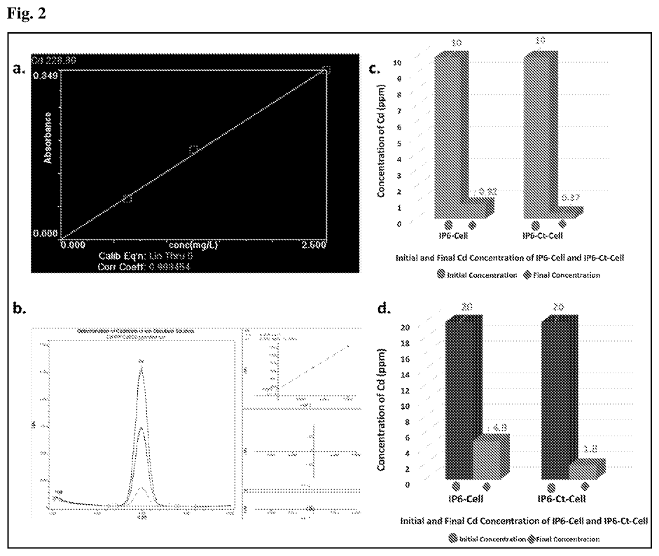

The atomic absorption spectroscopy (AAS) and differential pulse anodic stripping voltammeter (DPASV) were again used to study the difference in the adsorption of heavy metals between IP₆-citrate modified cellulose (IP₆-Ct-Cell) and IP₆-modified cellulose (IP₆—Cell). To demonstrate the superiority of IP₆-Ct-Cell over IP₆-Cellulose in scavenging heavy metals from solution, IP₆-Cellulose was prepared and incubated with solutions of Cd with varying concentrations. A similar set of experiments were carried out for IP₆-Ct-Cell. Cadmium solution with concentrations of 10 ppm and 20 ppm, were each separately mixed with IP₆-Ct-Cell and IP₆-Cell, stirred over a period of 15 minutes, filtered, and the filtrate used for the analysis. After interaction with Cd and filtrations, the 10 ppm solutions were analyzed with atomic absorption spectroscopy and the 20 ppm solutions were tested with differential pulse anodic stripping voltammetry at hanging mercury-dropping electrode. Thus, the IP₆-Cellulose served as the control for IP₆-Citrate-Cellulose. The results of the measurements are displayed in FIG. 2. In general, both the IP₆-Cellulose and IP₆-Citrate-Cellulose removed Cd from the solution but to a greater extent in the case of IP₆-Citrate-Cellulose. The amount of Cd remaining after 10 ppm of Cd solution was stirred with IP₆-Cell was nearly three times more than that of IP₆-Ct-Cell. However, more than 90% of the metal was removed from the solutions in both cases. A similar trend was observed for the 20 ppm solutions analyzed with differential pulse anodic stripping voltammetry at a hanging mercury-dropping electrode. With IP₆-Cell, 4.9 ppm was detected in the final solution whereas, in the case of IP-Ct-Cell, the amount detected was 1.8 ppm accounting for 91% removal of the Cadmium from the solution. Thus, the DPASV study showed that the IP₆-modified cellulose was more effective in removing the Pb²⁺ than the corresponding IP₆-modified cellulose.

Differences in the Analysis by Atomic Absorption Spectrometry and Differential Pulse Anodic Stripping Voltammetry

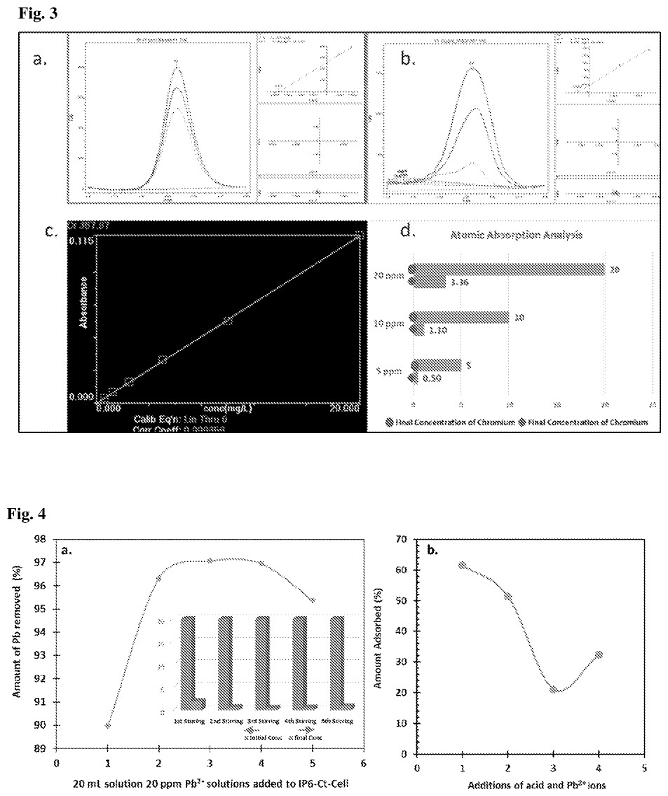

The results obtained using the atomic absorption spectrometry were generally consistent with those obtained by using differential pulse anodic stripping voltammetry, however, differential pulse anodic stripping voltammetry is oxidation state-selective, as opposed to the atomic absorption which measures the total amount of metals, therefore species in the samples capable of oxidizing turn to show up as unknown peaks in the cyclic voltammogram. When the peaks of these species are near the peak of interest, they tend to interfere with the peak of interest and impact the amount detected. This phenomenon is illustrated with the analysis of chromium both differential pulse anodic stripping voltammetry and the atomic absorption spectrometry. To correctly measure the amount of chromium remaining after incubation with a known concentration of chromium standards below 20 ppm were prepared and tested to provide a framework for the analysis of the IP₆-citrate modified cellulose. Standardization was carried out via the standard addition method. The Calibration curve of 20 ppm chromium standard solution via ASV is displayed in FIG. 3a, and that of AAS is displayed in FIG. 3b.

The stripping voltammograms were recorded over the potential range of −0.12 V to −0.60 V and the peak in the current signal was at a potential of −0.85 V. The final concentration of the 10 ppm chromium solution after incubation with IP₆-Ct-Cell was 1.10 ppm according to the atomic absorption measurement (FIG. 3d). But it was higher, 2.77 ppm, according to the differential pulse anodic stripping voltammetry (FIG. 3c). This could be attributed to a few factors but chief among them is the unknown peak located at a potential of −1.15 V. The unknown peak could be a species from the sample materials. It is noted this unknown peak was absent from the cyclic voltammogram of the 20 ppm chromium standard.

Adsorption Studies and the Effect of Acid on the Regeneration of IP₆-Ct-Cell Upon Binding with Pb

To perform adsorption studies, several solutions of 20 ppm Pb²⁺ were sequentially incubated with 0.5 g of IP₆-Ct-Cell to ascertain the binding capacity of IP₆-Ct-Cell. After each run, the mixture was filtered and the next batch of 20 ppm Pb²⁺ added to the IP₆-Ct-Cell from the previous run. The filtrates collected were subsequently tested with atomic absorption spectrometry and the results are displayed in FIG. 4a. It could be observed from the curve that the maximum removal of the Pb²⁺ occurred at the third washing of 20 ppm Pb²⁺ with the IP₆-Ct-Cell. After the third mixing of the IP₆-Ct-Cell with 20 ppm Pb²⁺ the amount of Pb²⁺ dropped slightly with each subsequent incubation yet the percent removed was still above as shown in FIG. 5a.

To ascertain the possibility of the regeneration of the IP₆-Ct-Cell, additional solutions of 20 ppm Pb²⁺ were added to the IP₆-Ct-Cell until the percentage of Pb²⁺ removed from the solution dropped below 30% as displayed in FIG. 4b. At this point, a 20 mL HCl solution was used to rinse the IP₆-Ct-Cl to reactivate it for further exposure to the metal ion. After the HCl treatment, the amount of Pb removed increased again. The adsorption studies were carried out to study the effect of acid on the regeneration of IP₆-Ct-Cell upon binding with Pb suggest that IP₆-Ct-Cell could be reused after careful treatment with dilute acid.

### LIST OF REFERENCES

(1) Jaishankar, M.; Tseten, T.; Anbalagan, N.; Mathew, B. B.; Beeregowda, K. N. Toxicity, Mechanism and Health Effects of Some Heavy Metals. Interdiscip. Toxicol. 2014, 7 (2), 60-72. https://doi.org/10.2478/intox-2014-0009.
(2) Sharma, B.; Singh, S.; Siddiqi, N. J. Biomedical Implications of Heavy Metals Induced Imbalances in Redox Systems. BioMed Res. Int. 2014, 2014, 640754-640754. https://doi.org/10.1155/2014/640754.
(3) Shah, V.; Daverey, A. Phytoremediation: A Multidisciplinary Approach to Clean up Heavy Metal Contaminated Soil. Environ. Technol. Innov. 2020, 18, 100774. https://doi.org/10.1016/j.eti.2020.100774.
(4) Bansod, B.; Kumar, T.; Thakur, R.; Rana, S.; Singh, I. A Review on Various Electrochemical Techniques for Heavy Metal Ions Detection with Different Sensing Platforms. Biosens. Bioelectron. 2017, 94, 443-455. https://doi.org/10.1016/j.bios.2017.03.031.
(5) Yuanyuan, L.; Liang, X.; Niyungeko, C.; Junjie, Z.; Guangming, T. A Review of the Identification and Detection of Heavy Metal Ions in the Environment by Voltammetry. Talanta, 2017, 178. https://doi.org/10.1016/j.talanta.2017.08.033.
(6) Koelmel, J.; Amarasiriwardena, D. Imaging of Metal Bioaccumulation in Hay-Scented Fern (DennstaedtiaPunctilobula) Rhizomes Growing on Contaminated Soils by Laser Ablation ICP-MS. Environ. Pollut. 2012, 168, 62-70. https://doi.org/10.1016/j.envpol.2012.03.035.
(7) Massadeh, A. M.; Alomary, A. A.; Mir, S.; Momani, F. A.; Haddad, H. I.; Hadad, Y. A. Analysis of Zn, Cd, As, Cu, Pb, and Fe in Snails as Bioindicators and Soil Samples near Traffic Road by ICP-OES. Environ. Sci. Pollut. Res. 2016, 23 (13), 13424-13431. https://doi.org/10.1007/s11356-016-6499-2.
(8) Sreenivasa Rao, K.; Balaji, T.; Prasada Rao, T.; Babu, Y.; Naidu, G. R. K. Determination of Iron, Cobalt, Nickel, Manganese, Zinc, Copper, Cadmium and Lead in Human Hair by Inductively Coupled Plasma-Atomic Emission Spectrometry. Spectrochim. Acta Part B At. Spectrosc. 2002, 57(8), 1333-1338. https://doi.org/10.1016/S0584-8547(02)00045-9.
(9) Ghann, W.; Harris, T.; Kabir, D.; Kang, H.; Jiru, M.; Rahman, M. M.; Ali, M. M.; Uddin, J. Lipoic Acid Decorated Gold Nanoparticles and Their Application in the Detection of Lead Ions. J. Nanomedicine Nanotechnol. 2019, 10 (6). https://doi.org/10.35248/2157-7439.19.10.539.
(10) Daşbaşi, T.; Saçmaci, Ş.; Çankaya, N.; Soykan, C. A New Synthesis, Characterization and Application Chelating Resin for Determination of Some Trace Metals in Honey Samples by FAAS. Food Chem. 2016, 203, 283-291. https://doi.org/10.1016/j.foodchem.2016.02.078.
(11) Fang, Y.; Liu, X.; Wu, X.; Tao, X.; Fei, W. Electrospun Polyurethane/Phytic Acid Nanofibrous Membrane for High Efficient Removal of Heavy Metal Ions. Environ. Technol. 2019, 1-8. https://doi.org/10.1080/09593330.2019.1652695.
(12) Kuo, C.-Y.; Wu, C.-H.; Chen, M.-J. Adsorption of Lead Ions from Aqueous Solutions by Citric Acid-Modified Celluloses. Desalination Water Treat. 2015, 55 (5), 1264-1270. https://doi.org/10.1080/19443994.2014.926460.
(13) Cigala, R. M.; Crea, F.; Stefano, C. D.; Lando, G.; Milea, D.; Sammartano, S. Electrochemical Study on the Stability of Phytate Complexes with Cu²⁺, Pb²⁺, Zn²⁺, and Ni²⁺: A Comparison of Different Techniques. J. Chem. Eng. Data, 2010, 55 (11), 4757-4767. https://doi.org/10.1021/je100384f.
(14) Cebrian, D.; Tapia, A.; Real, A.; Morcillo, M. A. Inositol Hexaphosphate: A Potential Chelating Agent for Uranium. Radiat. Prot. Dosimetry, 2007, 127 (1-4), 477-479. https://doi.org/10.1093/rpd/ncm356.
(15) Zhang, W.; Fan, S.; Li, X.; Liu, S.; Duan, D.; Leng, L.; Cui, C.; Zhang, Y.; Qu, L. Electrochemical Determination of Lead(II) and Copper(II) by Using Phytic Acid and Polypyrrole Functionalized Metal-Organic Frameworks. Microchim. Acta, 2019,187 (1), 69. https://doi.org/10.1007/s00604-019-4044-y.
(16) Wang, J.; Guan, H.; Han, Q.; Tan, S.; Liang, Q.; Ding, M. Fabrication of Yb3+-Immobilized Hydrophilic Phytic-Acid-Coated Magnetic Nanocomposites for the Selective Separation of Bovine Hemoglobin from Bovine Serum. ACS Biomater. Sci. Eng. 2019, 5 (6), 2740-2749. https://doi.org/10.1021/acsbiomaterials.9b00074.
(17) Ben Ali, M.; Wang, F.; Boukherroub, R.; Lei, W.; Xia, M. Phytic Acid-Doped Polyaniline Nanofibers-Clay Mineral for Efficient Adsorption of Copper (II) Ions. J. Colloid Interface Sci. 2019, 553, 688-698. https://doi.org/10.1016/j.jcis.2019.06.065.
(18) Wei, X.; Liu, Q.; Zhang, H.; Liu, J.; Chen, R.; Li, R.; Li, Z.; Liu, P.; Wang, J. Rapid and Efficient Uranium(VI) Capture by Phytic Acid/Polyaniline/FeOOH Composites. J. Colloid Interface Sci. 2018, 511, 1-11. https://doi.org/10.1016/j.jcis.2017.09.054.
(19) Yuan, F.; Wu, C.; Yawen, C.; Zhang, L.; Wang, J.-Q.; Chen, L.; Wang, X.; Yang, S.; Wang, S. Synthesis of Phytic Acid-Decorated Titanate Nanotubes for High Efficient and High Selective Removal of U(VI). Chem. Eng. J. 2017, 322. https://doi.org/10.1016/j.cej.2017.03.156.
(20) Kim, H. J.; Im, S.; Kim, J. C.; Hong, W. G.; Shin, K.; Jeong, H. Y.; Hong, Y. J. Phytic Acid Doped Polyaniline Nanofibers for Enhanced Aqueous Copper(II) Adsorption Capability. ACS Sustain. Chem. Eng. 2017, 5 (8), 6654-6664. https://doi.org/10.1021/acssuschemeng.7b00898.
(21) Lei, H.; Pan, N.; Wang, X.; Zou, H. Facile Synthesis of Phytic Acid Impregnated Polyaniline for Enhanced U(VI) Adsorption. J. Chem. Eng. Data, 2018, 63 (10), 3989-3997. https://doi.org/10.1021/acs.jced.8b00688.
(22) Ben Ali, M.; Wang, F.; Boukherroub, R.; Xia, M. High Performance of Phytic Acid-Functionalized Spherical Poly-Phenylglycine Particles for Removal of Heavy Metal Ions. Appl. Surf. Sci. 2020, 518, 146206. https://doi.org/10.1016/j.apsusc.2020.146206.
(23) Khan, N. A.; Jhung, S. H. Phytic Acid-Encapsulated MIL-101(Cr): Remarkable Adsorbent for the Removal of Both Neutral Indole and Basic Quinoline from Model Liquid Fuel. Chem. Eng. J. 2019, 375, 121948. https://doi.org/10.1016/j.cej.2019.121948.
(24) Lehrfeld, J. Cation Exchange Resins Prepared from Phytic Acid. J. Appl. Polym. Sci. 1997, 66 (3), 491-497. https://doi.org/10.1002/(SICI)1097-4628(19971017)66:3<491::AID-APP9>3.0.CO; 2-K.
(25) Bohn, L.; Meyer, A. S.; Rasmussen, Søren. K. Phytate: Impact on Environment and Human Nutrition. A Challenge for Molecular Breeding. J. Zhejiang Univ. Sci. B, 2008, 9 (3), 165-191. https://doi.org/10.1631/jzus.B0710640.
(26) Bizzarri, M.; Dinicola, S.; Bevilacqua, A.; Cucina, A. Broad Spectrum Anticancer Activity of Myo-Inositol and Inositol Hexakisphosphate. Int. J. Endocrinol. 2016, 2016, 5616807-5616807. https://doi.org/10.1155/2016/5616807.
(27) Nikhil, V.; Jaiswal, S.; Bansal, P.; Arora, R.; Raj, S.; Malhotra, P. Effect of Phytic Acid, Ethylenediaminetetraacetic Acid, and Chitosan Solutions on Microhardness of the Human Radicular Dentin. J. Conserv. Dent. 2016, 19 (2), 179-183. https://doi.org/10.4103/0972-0707.178705.
(28) Nassar, M.; Hiraishi, N.; Tamura, Y.; Otsuki, M.; Aoki, K.; Tagami, J. Phytic Acid: An Alternative Root Canal Chelating Agent. J. Endod. 2015, 41 (2), 242-247. https://doi.org/10.1016/j.joen.2014.09.029.
(29) Ekholm, P.; Virkki, L.; Ylinen, M.; Johansson, L. The Effect of Phytic Acid and Some Natural Chelating Agents on the Solubility of Mineral Elements in Oat Bran. Food Chem. 2003, 80 (2), 165-170. https://doi.org/10.1016/S0308-8146(02)00249-2.
(30) Di Palma, L.; Mecozzi, R. Heavy Metals Mobilization from Harbour Sediments Using EDTA and Citric Acid as Chelating Agents. J. Hazard. Mater. 2007, 147 (3), 768-775. https://doi.org/10.1016/j.jhazmat.2007.01.072.
(31) Beiyuan, J.; Tsang, D. C. W.; Valix, M.; Baek, K.; Ok, Y. S.; Zhang, W.; Bolan, N. S.; Rinklebe, J.; Li, X.-D. Combined Application of EDDS and EDTA for Removal of Potentially Toxic Elements under Multiple Soil Washing Schemes. Chemosphere, 2018, 205, 178-187. https://doi.org/10.1016/j.chemosphere.2018.04.081.
(32) Yin, X.; Chen, J.-J.; Lu, C. [Impact of compounded chelants on removal of heavy metals and characteristics of morphologic change in soil from heavy metals contaminated sites]. Huan Jing KeXueHuanjingKexue, 2014, 35 (2), 733-739.
(33) Yin, X.; Chen, J.-J.; Cai, W.-M.; Evaluation of compounding EDTA and citric acid on remediation of heavy metals contaminated soil. Huan Jing KeXueHuanjingKexue, 2014, 35 (8), 3096-3101.
(34) Shamsuddin, A. K. M. & Yang, G-Y: Inositol & Its Phosphates: Basic Science to Practical Applications. eISBN 9781681080079 ISBN: 9781681080086 Bentham e-Book, Bentham Science Publishers, Sharjah, U A E 2015. DOI: 10.2174/97816810800791150101
(35) Shamsuddin A M: Reduction of cell proliferation and enhancement of NK-cell activity, U.S. Pat. No. 5,082,833 Jan. 21, 1992.
(36) Coppolino C A and Shamsuddin A M: Phytic citrate compounds and the process for preparing the same, U.S. Pat. No. 7,989,435 Aug. 2, 2011
(37) Coppolino C A and Shamsuddin A M: Phytic citrate compounds and the process for preparing the same, U.S. Pat. No. 7,517,868 Apr. 14, 2009
(38) Coppolino C A: Hexa-citrated phytate and process of preparation thereof, U.S. Pat. No. 7,009,067 Mar. 7, 2006

### INCORPORATION BY REFERENCE

The entire contents of all patents, published patent applications and other references cited herein are hereby expressly incorporated herein in their entireties by reference.

### EQUIVALENTS

Those skilled in the art will recognize, or be able to ascertain using no more than routine experimentation, many equivalents to the specific embodiments and methods described herein. Such equivalents are intended to be encompassed by the scope of the following claims.

It is understood that the detailed examples and embodiments described herein are given by way of example for illustrative purposes only, and are in no way considered to be limiting to the disclosure. Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the systems, methods, and processes of the present disclosure will be apparent from the appended claims. Moreover, those skilled in the art will recognize, or be able to ascertain using no more than routine experimentation, many equivalents to the specific embodiments of the disclosure described herein. Such equivalents are intended to be encompassed by the following claims.

What is claimed is:

1. A method for the removal of heavy metal contamination from water comprising contacting contaminated water with inositol hexakisphosphate-hexacitrate (IP₆-citrate) to produce purified water.

2. The method of claim 1, wherein the IP₆-citrate is provided as a IP₆-citrate-modified cellulose material.

3. The method of claim 2, wherein the IP₆-citrate-modified cellulose is in the form of particles.

4. The method of claim 3, wherein the IP₆-citrate-modified cellulose particles are mixed with contaminated water followed by filtration to remove the IP₆-citrate-modified cellulose particles.

5. The method of claim 4, wherein the IP₆-citrate-modified cellulose particles are mixed with contaminated water in an amount of about 0.25-2.5 g/kg contaminated water.

6. The method of claim 4, wherein the IP₆-citrate-modified cellulose particles are mixed with contaminated water for about 1-30 minutes.

7. The method of claim 3, wherein the IP₆-citrate-modified cellulose particles are used to prepare a packed bed of IP₆-citrate-modified cellulose particles.

8. The method of claim 7, wherein contaminated water is passed over the packed bed of IP₆-citrate-modified cellulose particles to produce the purified water.

9. The method of claim 1, wherein the heavy metal contaminated water is contaminated with antimony, arsenic, cadmium, cerium, chromium, copper, europium, iron, nickel, lead, lithium, magnesium, mercury, molybdenum, potassium, sodium, zinc, or mixtures thereof.

10. The method of claim 1, wherein the purified water contains 5% or less of the heavy metals contained in the heavy metal contaminated water.

11. The method of claim 10, wherein the purified water contains 2% or less of the heavy metals contained in the heavy metal contaminated water.

12. The method of claim 12, wherein the purified water contains 1% or less of the heavy metals contained in the heavy metal contaminated water.

13. A filtration device comprising IP₆-citrate.

14. The filtration devise of claim 9, wherein the IP₆-citrate is an IP₆-citrate-modified cellulose.

15. A kit for purifying heavy metal contaminated water comprising IP₆-citrate and instructions for removing heavy metals from the heavy metal contaminated water using the IP₆-citrate.

16. The kit according to claim 16 wherein the IP₆-citrate is provided as an IP₆-citrate-modified cellulose.

17. A method for preparing IP₆-citrate-modified cellulose comprising reacting inositol hexakisphosphate with citric acid to form inositol hexakisphosphate-hexacitrate (IP₆-citrate);
and reacting the IP₆-citrate with a cellulose containing material in a solvent to produce the IP6 citrate-modified cellulose.
